(19) United States
(12) Patent Application Publication
(10) Pub. No.: US 2009/0148808 A1
(43) Pub. Date: Jun. 11, 2009

(54) Dental Device Comprising a Light Guide and a Light Source

(76) Inventors: Mike Alexander, Edmonton (CA); Michael Trzecleski, Hong kong (HK)

Correspondence Address: Michael Trzecieski, Flat 1a Caineway Mansion, 130 Caine Rd, Mid Levels, HK

(21) Appl. No.: 12/329,043

(22) Filed: Dec. 5, 2008

Related U.S. Application Data
(60) Provisional application No. 60/992,727, filed on Dec. 6, 2007.

(51) Int. Cl. A61C 19/06; A61C 15/04; A46B 9/04

(52) U.S. Cl. 433/29; 132/323; 15/167.1

(57) ABSTRACT

A novel dental device is disclosed for facilitating oral hygiene. The device includes a light source and a light guide, where light from the light source is propagated through the light guide so that it refracts from the end thereof. Through this refraction it at least partially illuminates bristles, or dental floss or a dental pick and in use illuminates, at least partially, teeth and gums within the mouth. Preferably the dental device utilizes a light source of such a wavelength that facilitates killing of bacteria.

This application claims priority from U.S. Provisional Application No. 60/992,727 Filed on Dec. 6, 2007.

### FIELD OF THE INVENTION

The field of the invention relates to dental devices and more specifically to dental devices for facilitating oral hygiene.

### BACKGROUND OF THE INVENTION

It is a well understood fact that regular brushing and flossing of teeth is an effective means of promoting oral hygiene. There are many devices that are available in the market for promoting of oral hygiene, such as toothbrushes and flossing devices. Typically these devices are utilized with other compounds such as toothpaste and mouthwash. In addition to maintain proper oral hygiene, it is recommended to provide some element of mechanical motion to the toothbrush or flossing device in order to facilitate removal of plaque or other unwanted oral bacteria. Unfortunately, when these devices are used they accumulate bacteria on the bristles or on the floss.

In addition, it is well known in the art to utilize light to facilitate killing of bacteria. Such a light having wavelength that is either in the infrared or ultraviolet spectra. Unfortunately, the currently available dental flossing devices as well as toothbrushes do not provide any hygienic effect that could be provided by the application of light. In some cases, toothbrushes with light sources embedded in the head exist, however in the case of lasers, this results in a bulky device that is hard to put into the mouth. Furthermore, safety issues, such as light being emitted from the laser falling into the eyes of an individual is also an issue.

It is therefore an object of the present invention to provide dental devices that overcomes deficiencies of the prior art.

### SUMMARY OF THE INVENTION

In accordance with the invention there is provided a dental device comprising:

a body comprising a handle and a head for being at least partially inserted into a mouth; a light source for emitting light of at least a wavelength and disposed within the body opposite the head; a light guide having a first end optically coupled with the light source and a second end disposed proximate the head, wherein the second end of the light guide is for refracting at least a portion of the light emitted from the light source into the air for illuminating at least a portion of an inside of the mouth; a control circuit coupled with the light source; and a battery compartment coupled with the control circuit.

In accordance with the invention there is provided a method comprising: providing a dental device body; providing handle as part of the body; providing a head as part of the body opposite the handle; providing a light source disposed in the handle; providing a light guide optically coupled with the light source at a first end; providing at least a surface for refraction of the light guide at a second end, which is opposite the first end; propagating light from the light source through the light guide; and refracting light from the at least a surface for refraction proximate the head.

In accordance with the invention there is provided a dental device comprising:

a body comprising a handle and a head, where the head is disposed opposite the handle;
a light source for emitting light of at least a wavelength and disposed within the body opposite the head; at least one of bristles and dental floss and a dental pick disposed proximate the head; a light guide having a first end optically coupled with the light source and a second end disposed proximate the head, wherein the second end of the light guide is for refracting at least a portion of the light emitted from the light source into the air for illuminating at least one of bristles and dental floss and a dental pick; a control circuit coupled with the light source; and a battery compartment coupled with the control circuit.

### BRIEF DESCRIPTION OF THE DRAWINGS

Exemplary embodiments of the invention will now be described in conjunction with the following drawings, in which:

FIG. 1a illustrates a Prior Art tooth flossing apparatus 100;

FIG. 2a illustrates cutaway view of a tooth flossing apparatus in accordance with a first embodiment of the invention;

FIG. 2b illustrates perspective view of a tooth flossing apparatus in accordance with a first embodiment of the invention;

FIG. 2c illustrates light refracting from second and third ends of a light guide that forms a portion of the tooth flossing apparatus;

FIG. 2d illustrates a variation of the embodiment shown in FIG. 2a in a cutaway view of the head;

FIG. 3a illustrates a second embodiment of the invention, a tooth brushing apparatus;

FIG. 3b illustrates a variation of the second embodiment of the invention that includes a removable head;

FIG. 3c illustrates a blown up view of a head forming the second embodiment of the invention;

FIG. 4a illustrates a prior art brush 400 known as the proxy Brush™;

FIG. 4b illustrates a third embodiment of the invention, a single sided flossing device (SSFD) in accordance with a third embodiment of the invention;

FIG. 4c illustrates an blown up view of the head forming the third embodiment of the invention;

FIG. 4d illustrates a variation of the embodiment that is shown in FIG. 4b.

### DESCRIPTION OF EMBODIMENTS OF THE INVENTION

FIG. 1a illustrates a Prior Art tooth flossing apparatus 100. The tooth flossing apparatus 100 is formed from a body 188 having a handle 101 and a head 150. The head 150 divides into a first arm 102 and a second arm 103 forming a gap 299 in between the arms, where this gap is an air gap. Floss 106 is wound around a bobbin 104 then propagated along a length of the first arm 102 where it is disposed into a first groove 102a. Thereafter it is stretched across the gap 299 between the first and second arms, 102 and 103, where at the second arm 103 it is disposed into a second groove 102b and thereafter wound around the bobbin 104. Winding the floss 106 in this manner preferably facilitates it being under tension across the gap 299.

As is known to those of skill in the art, in use of the tooth flossing apparatus 100, at least a portion of the head 150 having the first and second arms, 102 and 103, is inserted into the mouth. Once the at least a portion of the head 150 is in the mouth, the floss 106 is inserted into a space between two teeth of a user where preferably the teeth are then found between the first and second arms, 102 and 103. The handle 101 is then moved around thus facilitating motion of the floss 106 within the space between the two teeth in a manner in accordance with known oral hygiene practice. Unfortunately, the tooth flossing apparatus 100 only removes bacteria from the space between the teeth using a mechanical means and does not provide any further means of killing the bacteria that are found on the teeth themselves and between the teeth.

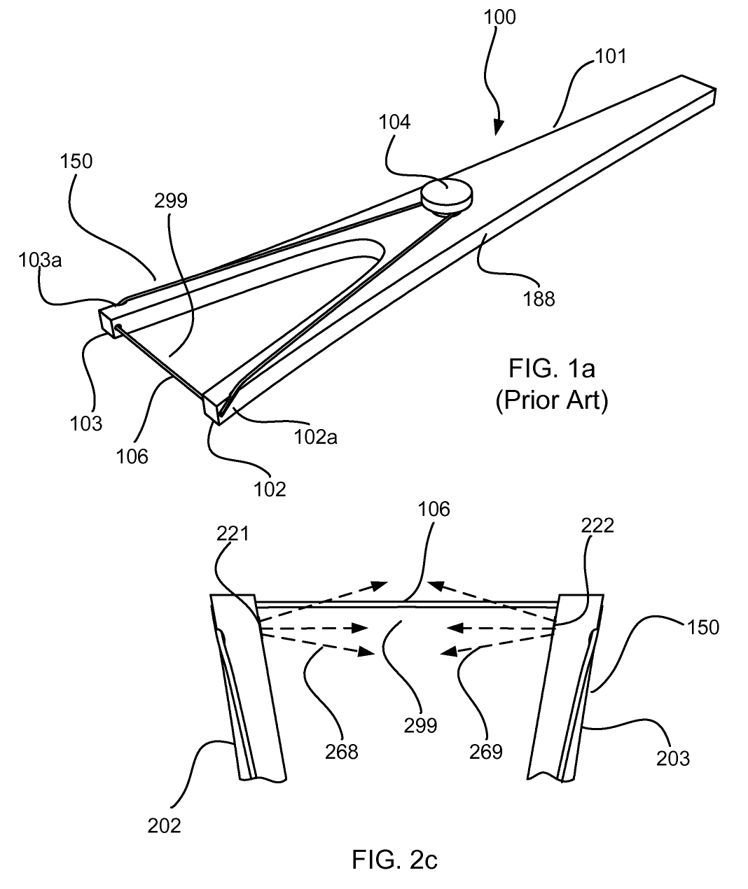

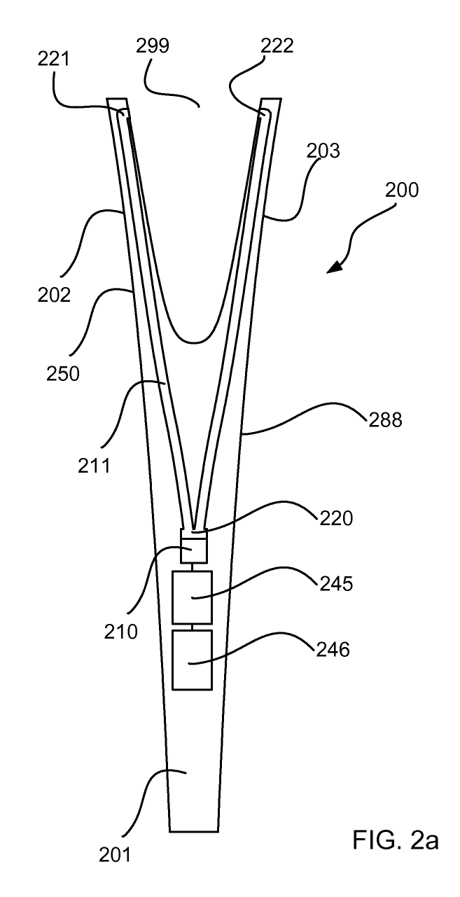

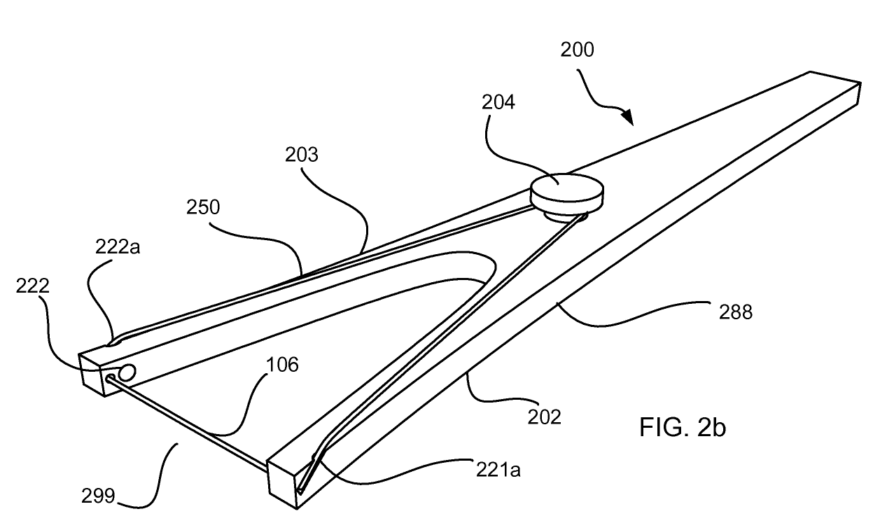

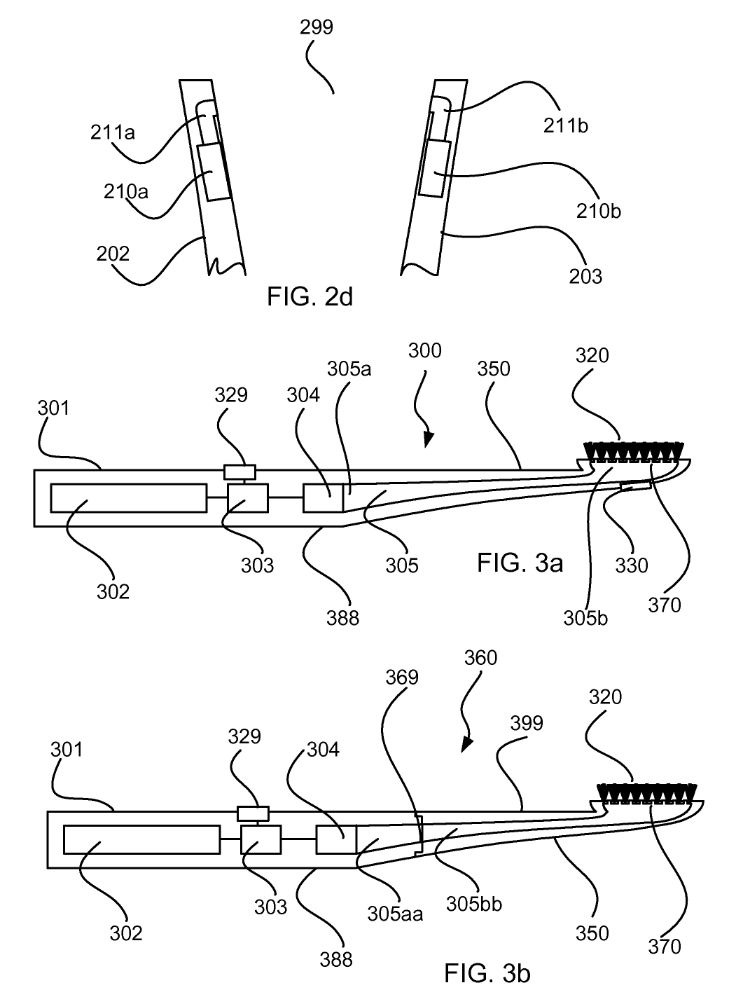

FIG. 2a illustrates cutaway view of a tooth flossing apparatus (TFA) 200 in accordance with a first embodiment of the invention. The TFA 200 is formed from a body 288 that includes a handle 201 and a head 250 disposed opposite the handle 201. The head 250 divides into a first arm 202 and a second arm 203 forming a gap 299 in between.

Disposed within the body 288 of the TFA 200 is a light guide 211 having a first end 220 optically coupled with the light source 210 and a second end 221 disposed proximate the head 250 for propagating of light from the light source 210 along the first arm 202 and having a third end 222 for propagating of light from the light source 210 along the second arm 203. The second end 221 and the third end 222 of the light guide 211 are for refracting of at least a portion of the light emitted from the light source 210 into the gap 299. A control circuit 245 and a battery compartment 246 are provided within the handle 201. The control circuit 245 is coupled with the light source 210 and the battery compartment 246 for controlling of a provision of electrical power to the light source from a battery inserted into the battery compartment 246.

With reference to FIG. 2b. in use, the head 250 of the TFA 200 is at least partially inserted into a mouth of a user such that and the floss 106 is inserted into a space between two teeth of the user where preferably the teeth are then situated in the gap 299 between the first and second arms, 202 and 203. Preferably the handle 201 is then moved around thus facilitating motion of the floss 106 within the space between the two teeth. In addition, light is emitted from the light source 210 and it refracts from the second and third ends of the light guide, 221 and 222, respectively, for illuminating teeth and gums within the mouth.

Preferably the light source 210 is a laser light source having a wavelength that falls within the infrared or ultraviolet optical spectrum. For example, the wavelength of approximately 632 nm is envisaged. Optionally the light source 210 is in the form of a LED light source. Preferably the wavelength of the light source is such that it facilitates killing of bacteria.

Referring to FIG. 2b, a perspective view of the TFA 200 is shown. In this figure, floss 106 is wound around a bobbin 204, where the floss 106 then propagates along a length of the first arm 202 where it is disposed into a first groove 221a. Thereafter it is stretched across the gap 299 between the first and second arms, 202 and 203, where at the second arm 203 it is disposed into a second groove 222a and thereafter wound around the bobbin 204. Preferably, winding the floss 106 in this manner facilitates it being under tension across the gap 299. The third end 222 of the TFA 200 is shown from a perspective view in this figure and the second end 221 is not visible.

Referring to FIGS. 2c and 2a, in use, the light from the light source 210 travels within the light guide 211, preferably using at least one of internal reflection and refraction, where preferably at least a majority of the light is not scattered out from the light guide 211. Optionally, in proximity of the second and third ends, 221 and 222, respectively, an approximately forty five degree bend in the light guide 211 is formed such that at least a substantial amount of light that is emitted from the light source 210 refracts from the second and third ends, 221 and 222, and is emitted into the gap 299 thus at least partially illuminating the floss 106 as well at least partially illuminating the teeth and gums when the TFA 200 is inserted into the mouth. An example of such refraction is shown in FIG. 2c, where light 268 and 269 is refracting from the light guide 211 in proximity of the second and third ends, 221 and 222, respectively.

FIG. 2d illustrates a variation of the embodiment shown in FIG. 2a in a cutaway view of the head 250, where in this embodiment instead of there being a single light source 210, there is a first light source 210a and a second light source 210b. The first light source 210a is for providing of light into a first light guide 211a and the second light source 210b is for providing of light into a second light guide 211b. A first end of each light guide is optically coupled with a respective light source and a second end of each light guide is for refracting of light optically coupled from the respective light source into the gap 299.

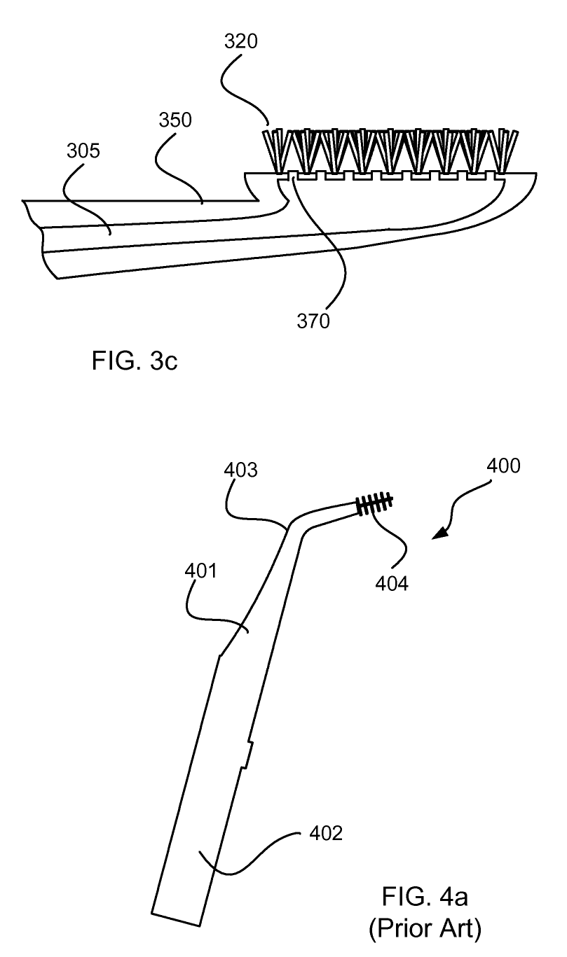

FIG. 3a illustrates a second embodiment of the invention, a tooth brushing apparatus (TFA) 300. The TFA is formed from a body 388 having a handle 301 and having a head 350 for being at least partially inserted into a mouth. The head 350 includes bristles 320 for use in brushing of teeth and gums within the mouth. A light source 304 for emitting light of a wavelength is disposed within the body 388 opposite the head 350. A light guide 305 having a first end 305a is optically coupled with the light source 304. The light guide 305 has a second end 305b disposed proximate the head 350 wherein the second end 305b is for refracting at least a portion of the light emitted from the light source 304 for illuminating at least a portion of the bristles 320 in addition at least a portion into the air. Optionally a control button 329 is provided and coupled with the control circuit 303 for controlling operation thereof. FIG. 3c illustrates a magnified view of the head 350 as is shown in FIG. 3a.

Preferably, within the handle 301 there is disposed a battery compartment 302 for containing a battery, which is electrically coupled to an optional control circuit 303, which is electrically coupled to the light source 304, which is optically coupled to the light guide 305. The refraction facilitates illumination of the bristles 320 by the light source 304 and occurs in areas where the light from the light source 304 refracts from the light guide 305 through a plurality of apertures 370 formed within the body 388 proximate the head 350. As light refracts from the plurality of apertures 370, it facilitates illuminating at least a portion of the bristles 320 and preferably for illuminating teeth and gums within the mouth, when in use.

Optionally, at least some of the bristles 320 are optically coupled with the light guide 305 for facilitating propagation of at least a portion of the light emitted from the light source 304.

Further optionally, as is shown in FIG. 3a, a capacitive sensor plate 330 is disposed in proximity of the head 350 and electrically coupled with the control circuit 303. The control circuit 303 utilizes the capacitive sensing plate 330 to determine a presence or absence of capacitance in proximity of the head 350. Upon determining a presence of a capacitance, such as human flesh, it enables the light source 304 to provide light into the light guide 305. In the case when an absence of the capacitance is determined, it optionally disables of light being provided from the light source 303 into the light guide 305. It is well known in the art that animate objects, such as human flesh, have a capacitance associated with them. Advantageously, the enabling and disabling of the light source 303 in dependence upon the capacitance reduces a risk associated with shining light from the light source 304 into an eye of a user.

FIG. 3b illustrates a variation of the second embodiment of the invention 360 that includes a removable head 399. Referring to the second embodiment of the invention, the light guide 305 is split into two parts, 305aa and 305bb. Using a releasable coupling 369, the removable head 399 is one of coupled to the handle 301 and other than coupled to the handle 301 for facilitating replacement thereof. Within the releasable coupling 369, light from the light source propagates from the first part of the light guide 305aa into the second part of the light guide 305bb for being refracted from within the light guide into proximity of the bristles 320 through the apertures 370. The releasable coupling 369 also facilitates electrical coupling of the capacitive sensor plate 330 to the control circuit 303. Optionally a control button 329 is provided and coupled with the control circuit 303 for controlling operation thereof.

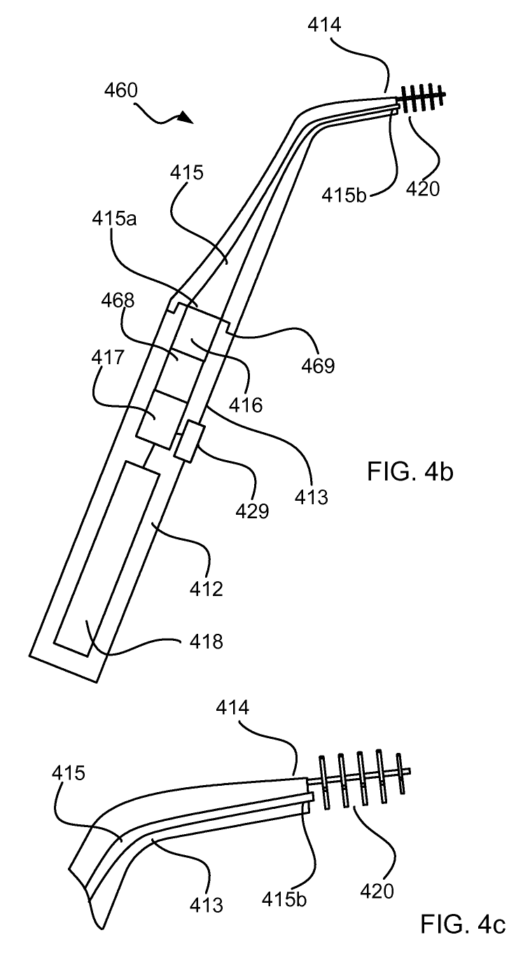

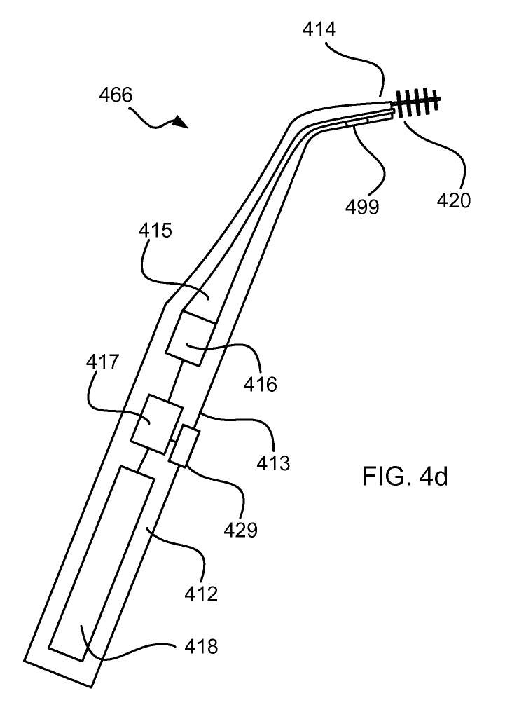

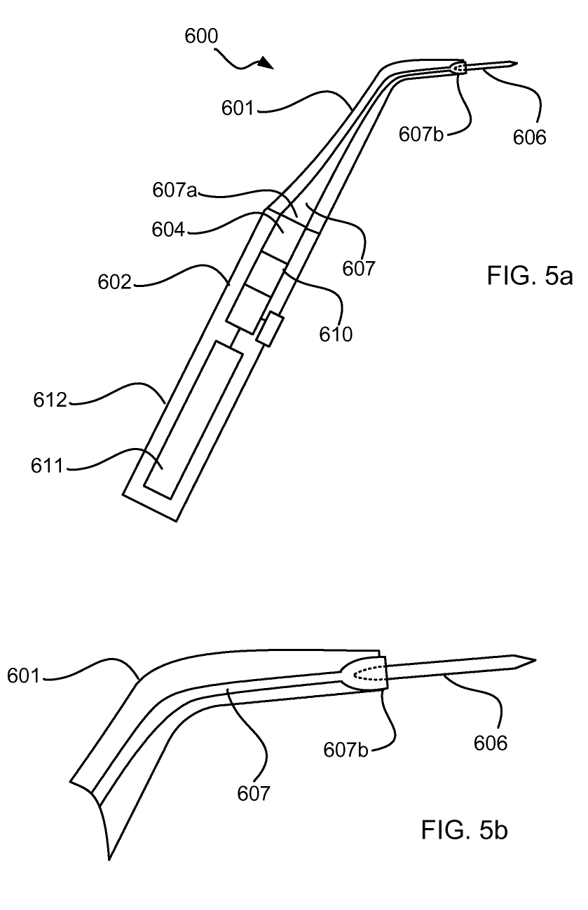

FIG. 4a illustrates a prior art brush 400 known as the proxy Brush™. This brush 400 is formed from a body 401 that includes a handle 402 and a head 403. Disposed in proximity of the head 403 is a brush 404 formed from a twisted wire with bristles embedded into the twists of the wire. This prior art brush 400 facilitates flossing of the teeth from one side of a space between the teeth. In use of this brush, 400, conventional flossing methods include approaching the space between teeth from a chewing surface of the tooth as opposed to a flat side of the tooth.

FIG. 4b illustrates a third embodiment of the invention, a single sided flossing device (SSFD) 460. The SSFD 460 is formed from a body 413 having a handle 412 and a head 414, which is opposite the handle 412, for being at least partially inserted into a mouth. A light source 416 for emitting light of a wavelength is disposed within the body 413 opposite the head 414 and optically coupled to a light guide 415. The light guide 415 has a first end 415a optically coupled with the light source 416 and a second end 415b disposed proximate the head 414, wherein the second end 415b is for refracting at least a portion of the light emitted from the light source 416 into the air proximate bristles 420. A control circuit 417 is coupled with the light source 416 and a battery compartment 418 for housing a battery. In use, light from the light source 416 propagates through the light guide 415 and refracts from the light guide 415 in proximity of the head 414 and illuminates the bristles 420 as well as preferably teeth and gums. Optionally the head 414 is removable from the handle 412 using a releasable coupling 469 as shown. Further optionally, a vibrating motor 468 is provided to vibrate the head 414 for facilitating movement thereof. Optionally a control button 429 is provided and coupled with the control circuit 417 for controlling operation thereof

FIG. 4c illustrates the light guide 415 and the head 414 in greater detail showing the preferred orientation of the bristles 420 in relation to the light guide 415 proximate the head 414.

Referring to FIG. 4d, a variation of the embodiment that is shown in FIG. 4b is illustrated 466. Optionally, a capacitive sensing plate 499 is disposed in proximity of the head 414 and coupled to the control circuit 417. The capacitive sensing plate 499 as well as the control circuit 417 for facilitating sensing a presence of gums of the user in order to control whether the light source 416 is enabled or disabled.

FIG. 5a illustrates a fifth embodiment of the invention, a vibrating pick apparatus (VPA) 600. The VPA 600 is formed a body 602 having a handle 621 opposite a head 601 for being at least partially inserted into a mouth. A light source 604 for emitting light of a wavelength is disposed within the body 602 opposite the head 601. A light guide 607 having a first end 607a is optically coupled with the light source 604 and has a second end 607b disposed proximate the head 601, wherein the second end 607b is for refracting at least a portion of the light emitted from the light source into the air. A removeable dental pick 606 is inserted into an aperture proximate the second end of the light guide 607b. Light refracting from the light guide 607 proximate the second end 607b at least partially illuminates the dental pick 606 as well as, when in use, a space between the teeth as well as a portion of the gums. A magnified view of the head 601, removeable dental pick 606 as well as the light guide 607 is shown in FIG. 5b.

A control circuit 605 and a battery compartment 611 are provided within the handle 612. The control circuit 605 is coupled with the light source 604 and the battery compartment 611 for controlling of a provision of electrical power to the light source 604 from a battery inserted into the battery compartment 611.

Further optionally, a vibrating motor 610 is coupled with the head 601 for providing vibrations thereto for facilitating the insertion of the removeable dental pick 606 into a space between the teeth. Optionally, capacitive sensing is also employed in this case as described in the other embodiments of the invention for improving operator safety.

Preferably the light source envisaged in the aforementioned embodiments of the invention is a laser light source having a wavelength of approximately 632 nm. Furthermore, for cost purposes, laser sources of such a wavelength have also become common place and as such would facilitate inexpensive manufacturing of the embodiments of the invention. Advantageously, providing a capacitance sensing plate as well as a control circuit comprising capacitance sensing electronics facilitates enabling and disabling operation of the light source in dependence upon the presence and absence of human gums. This advantageously reduces the risk of having light from a laser light source to shine into the eyes of a user.

Advantageously, by using a light guide and optical properties thereof to propagate the light from the light source within the light guide, the portion of the device that is used within the mouth of the individual is greatly reduced in size. The light source is remotely disposed outside of the mouth and fits comfortably within the handle thereof for facilitating gripping.

Advantageously, by also at least partially illuminating the bristles, dental pick or floss in accordance with the embodiments of the invention, an additional benefit is realized by killing at least some of the bacteria that collect on the bristles, dental pick or floss during use in oral hygiene.

Numerous other embodiments are envisaged without departing from the spirit or scope of the invention.

What is claimed is:

1. A dental device comprising:
a body comprising a handle and a head for being at least partially inserted into a mouth;
a light source for emitting light of at least a wavelength and disposed within the body opposite the head;
a light guide having a first end optically coupled with the light source and a second end disposed proximate the head, wherein the second end of the light guide is for refracting at least a portion of the light emitted from the light source into the air for illuminating at least a portion of an inside of the mouth;
a control circuit coupled with the light source; and,
a battery compartment coupled with the control circuit.

2. A dental device according to claim 1, wherein the light guide comprises a third end disposed proximate the head and optically coupled with the light source wherein the third end of the light guide is for refracting at least a portion of the light emitted from the light source into a gap formed between the second and third ends.

3. A dental device according to claim 2 wherein the gap is an air gap.

4. A dental device according to claim 1 wherein the head comprises a first arm disposed opposite a second arm forming a gap between the arms and where the second end of the light guide is for refracting at least a portion of the light emitted from the light source into the gap.

5. A dental device according to claim 4 wherein the first arm comprises a first groove and the second arm comprises a second groove for having dental floss disposed within these grooves for spanning the gap wherein the light from the light source that refracts from the second end at least partially illuminates the dental floss.

6. A dental device according to claim 1 wherein the head comprises bristles disposed proximate the second end of the light guide wherein the light from the light source that refracts from the second end at least partially illuminates the bristles.

7. A dental device according to claim 1 comprising a vibrating motor coupled with the control circuit for vibrating of the head.

8. A dental device according to claim 1 comprising:
a capacitive sensor plate coupled with the control circuit and disposed in the head in proximity of the second end of the light guide for coupling to the control circuit, the capacitive sensor plate for sensing at lease one of a presence of a capacitance proximate the second and an absence of a capacitance proximate the second end and for operating the light source in dependence thereon.

9. A dental device according to claim 1 wherein the light source is at least one of a laser light source and a LED light source.

10. A dental device according to claim 10 wherein the at least a wavelength of the light source is at least within an infrared and ultraviolet spectrum.

11. A dental device according to claim comprising: a removeable dental pick that is removeably coupled with the head and disposed proximate the second end of the light guide for being at least partially illuminated by light refracting from the second end of the light guide.

12. A dental device according to claim 1 comprising a releasable coupling between the head and the handle wherein the second end of the light guide is releasably coupled with the first end of the light guide for facilitating removing the head from the handle.

13. A dental device according to claim 1 wherein the at least a wavelength of the light source is within a wavelength range that facilitates killing of bacteria.

14. A method comprising:
providing a dental device body;
providing handle as part of the body;
providing a head as part of the body opposite the handle;
providing a light source disposed in the handle;
providing a light guide optically coupled with the light source at a first end;
providing at least a surface for refraction of the light guide at a second end, which is opposite the first end;
propagating light from the light source through the light guide; and
refracting light from the at least a surface for refraction proximate the head.

15. A method according to claim 13 comprising releasably coupling of the head with the handle.

16. A method according to claim 13 comprising: providing at least one of bristles and dental floss and a dental pick disposed proximate the head, wherein refracting comprises illuminating at least a portion of the at least one of bristles and dental floss and a dental pick.

17. A method according to claim 13 comprising: sensing a capacitance proximate the head and illuminating the light source in dependence upon a presence of the capacitance.

18. A dental device comprising:
a body comprising a handle and a head, where the head is disposed opposite the handle;
a light source for emitting light of at least a wavelength and disposed within the body opposite the head;
at least one of bristles and dental floss and a dental pick disposed proximate the head;
a light guide having a first end optically coupled with the light source and a second end disposed proximate the head, wherein the second end of the light guide is for refracting at least a portion of the light emitted from the light source into the air for illuminating at least one of bristles and dental floss and a dental pick;
a control circuit coupled with the light source; and,
a battery compartment coupled with the control circuit.

19. A dental device according to claim 18 comprising:
a capacitive sensor plate coupled with the control circuit and disposed in the head in proximity of the second end of the light guide for coupling to the control circuit, the capacitive sensor plate for sensing at lease one of a presence of a capacitance proximate the second and an absence of a capacitance proximate the second end and for operating the light source in dependence thereon.

20. A dental device according to claim 18 comprising a releasable coupling between the head and the handle wherein the second end of the light guide is releasably coupled with the first end of the light guide for facilitating removing the head from the handle.
